(19) United States
(12) Patent Application Publication
(10) Pub. No.: US 2016/0133189 A1
(43) Pub. Date: May 12, 2016

(54) ORGANIC LIGHT-EMITTING DISPLAY APPARATUS AND METHOD OF DRIVING THE SAME

(71) Applicant: Samsung Display Co., Ltd., Yongin-City (KR)

(72) Inventors: Byeongdoo Kang, Yongin-City (KR); Dongwon Moon, Yongin-City (KR); Jongman Bae, Yongin-City (KR)

(21) Appl. No.: 14/684,204

(22) Filed: Apr. 10, 2015

(30) Foreign Application Priority Data
Nov. 10, 2014 (KR) 10-2014-0155522

(51) Int. Cl. G09G 3/32

(52) U.S. Cl. CPC G09G 3/3258; G09G 2330/028; G09G 2310/08

(57) ABSTRACT

An organic light-emitting display includes: a pixel comprising a pixel circuit; a power supply configured to supply a first power voltage to the pixel circuit; a voltage divider configured to generate a power division voltage by dividing the first power voltage; a converter configured to generate a first digital value by performing an analog to digital (A/D) conversion of the power division voltage; a storage unit configured to store a first reference digital value generated by the converter, the first reference digital value corresponding to a first reference voltage and a second reference digital value generated by the converter, the second reference digital value corresponding to a second reference voltage that is different from the first reference voltage; and a voltage level determiner configured to determine a level of the first power voltage based on the first digital value, the first reference digital value, and the second reference digital value.

### CROSS-REFERENCE TO RELATED APPLICATION

This application claims priority to and the benefit of Korean Patent Application No. 10-2014-0155522, filed on Nov. 10, 2014, in the Korean Intellectual Property Office, the disclosure of which is incorporated herein in its entirety by reference.

### BACKGROUND

1. Field

One or more exemplary embodiments of the present invention relate to an organic light-emitting display apparatus and a method of driving the organic light-emitting display apparatus.

2. Description of the Related Art

An organic light-emitting display apparatus has been considered as a next generation display apparatus due to such features as wide viewing angles, fast response speeds, and low power consumption, as well as being lightweight and thin.

An organic light-emitting display apparatus displays images by using an organic light-emitting diode (OLED) for emitting light due to the recombination of electrons and holes. The light emission intensity of the OLED changes sensitively according to the amount of current in the OLED. The amount of current in the OLED is determined by a power voltage supplied to pixels. Therefore, a level of the power voltage should be measured in order to check whether or not the OLED is operating normally.

### SUMMARY

One or more exemplary embodiments of the present invention include an organic light-emitting display apparatus capable of measuring a level of a power voltage and a method of driving the same.

Additional aspects will be set forth in part in the description which follows and, in part, will be apparent from the description, or may be learned by practice of the presented embodiments.

According to one or more exemplary embodiments of the present invention, an organic light-emitting display apparatus includes: a pixel comprising a pixel circuit; a power supply for supplying a first power voltage to the pixel circuit; a voltage divider for generating a power division voltage by dividing the first power voltage; a converter for generating a first digital value by performing an analog to digital (A/D) conversion of the power division voltage; a storage unit for storing a first reference digital value generated by the converter, the first reference digital value corresponding to a first reference voltage and a second reference digital value generated by the converter, the second reference digital value corresponding to a second reference voltage that is different from the first reference voltage; and a voltage level determiner for determining a level of the first power voltage based on the first digital value, the first reference digital value, and the second reference digital value.

The voltage divider may include a first division resistor and a second division resistor, wherein the first division resistor and the second division resistor are connected between an output terminal of the power supply and a ground in series.

When it is assumed that a level of the first reference voltage is C1, a level of the second reference voltage is C2, a value obtained by dividing a magnitude of the first division resistor by a magnitude of the second division resistor is C3, a level of a reference voltage for the A/D conversion is C4, a number of bits in the first digital value is C5, the first reference digital value is D1, the second reference digital value is D2, and the first digital value obtained by converting an output voltage of the voltage divider by the converter is DC, the voltage level determiner may calculate a second digital value DM generated by the converter, the second digital value DM corresponding to the first power voltage by using the following equation:

$$DM = ( \frac{C 2 - C 1}{C 3 * C 4} ) * ( {2}^{C 5} ) * ( \frac{DC - D 1}{D 2 - D 1} ) ,$$

and the voltage level determiner may determine the level of the first power voltage using the second digital value.

A magnitude of the first division resistor and a magnitude of the second division resistor may be 1 Mohm or greater, respectively.

The organic light-emitting display apparatus may further include an adjustment signal output unit for generating a control signal for adjusting the first power voltage based on the determined level of the first power voltage and to output the control signal to the power supply.

The pixel may include an organic light-emitting diode (OLED) for receiving a driving current from the pixel circuit, and the power supply may supply a second power voltage to a cathode of the OLED.

The level of the first reference voltage may be substantially equal to a ground level.

The organic light-emitting display apparatus may further include: a display on which the pixel is disposed; a gate driver for outputting a scan signal; a source driver for outputting a data signal to the pixel in synchronization with the scan signal; and a controller for controlling the gate driver and the source driver.

According to one or more exemplary embodiments of the present invention, an organic light-emitting display apparatus includes: a display on which a plurality of regions are defined and comprising a plurality of pixels; and a plurality of circuits for supplying a power voltage to pixels on regions corresponding to the plurality of circuits among the plurality of regions; generating a power division voltage by dividing the power voltage; generating a first digital value by performing an analog to digital (A/D) conversion of the power division voltage; and determining a level of the power voltage based on a first reference digital value corresponding to a first reference voltage, a second reference digital value corresponding to a second reference voltage, and the first digital value, wherein the second reference voltage may be different from the first reference voltage.

The organic light-emitting display apparatus may further include: a reference power supply for supplying the first reference voltage and the second reference voltage to the plurality of circuits.

Each of the plurality of circuits may include: a power supply for supplying the power voltage to the pixels on the region corresponding to the circuit among the plurality of regions; a voltage divider for generating the power division voltage by dividing the power voltage; a converter for generating the first digital value by performing the A/D conversion of the power division voltage; a storage unit for storing the first reference digital value generated by the converter, the first reference digital value corresponding to the first reference voltage and the second reference digital value generated by the converter, the second reference digital value corresponding to the second reference voltage; and a voltage level determiner for determining a level of a first power voltage based on the first digital value, the first reference digital value, and the second reference digital value.

The voltage divider in each of the plurality of circuits may include a first division resistor and a second division resistor that are connected between an output terminal of the power supply and a ground in series.

Each of the plurality of circuits may include an adjustment signal output unit for generating a control signal for adjusting the first power voltage based on the determined level of the first power voltage and to output the control signal to the power supply.

The organic light-emitting display apparatus may further include: a gate driver for outputting a scan signal; a source driver for outputting a data signal to the plurality of pixels in synchronization with the scan signal; and a controller for controlling the gate driver and the source driver.

According to one or more exemplary embodiments of the present invention, a method of driving an organic light-emitting display apparatus includes: generating a first reference voltage; generating a first reference digital value through an analog to digital (A/D) conversion of the first reference voltage; generating a second reference voltage that is different from the first reference voltage; generating a second reference digital value through an A/D conversion of the second reference voltage; storing the first reference digital value and the second reference digital value; generating a first digital value based on a power voltage supplied to a display; and determining a level of the power voltage based on the first reference digital value, the second reference digital value, and the first digital value.

The generating of the first reference voltage, the generating of the first reference digital value, the generating the second reference voltage, the generating of the second reference digital value, and the storing of the first reference digital value and the second reference digital value may be performed between a time point at which electric power is supplied to the organic light-emitting display apparatus and a time point at which an image is displayed on the display.

### BRIEF DESCRIPTION OF THE DRAWINGS

These and/or other aspects will become apparent and more readily appreciated from the following description of exemplary embodiments of the present invention, taken in conjunction with the accompanying drawings in which:

FIG. 1 is a schematic diagram of an organic light-emitting display apparatus according to an embodiment of the present invention;

FIG. 2 is a schematic diagram of a converter of FIG. 1;

FIG. 3 is a schematic diagram of an organic light-emitting display apparatus according to another embodiment of the present invention;

FIG. 4 is a schematic diagram of an organic light-emitting display apparatus according to another embodiment of the present invention;

FIG. 5 is a flowchart illustrating a method of driving an organic light-emitting display apparatus, according to an embodiment of the present invention; and

FIG. 6 is a flowchart illustrating a method of driving an organic light-emitting display apparatus, according to another embodiment of the present invention.

### DETAILED DESCRIPTION

Reference will now be made in detail to exemplary embodiments of the present invention, examples of which are illustrated in the accompanying drawings, wherein like reference numerals refer to like elements throughout. In this regard, the exemplary embodiments of the present invention may have different forms and should not be construed as being limited to the descriptions set forth herein. Accordingly, the exemplary embodiments are merely described below, by referring to the figures, to explain aspects of the present description.

Hereinafter, embodiments of the present invention will be described in detail with reference to the accompanying drawings. In addition, in the present specification and drawings, like reference numerals refer to like elements throughout, and thus, redundant descriptions are omitted.

It will be understood that although the terms “first”, “second”, etc. may be used herein to describe various components, these components should not be limited by these terms. These components are only used to distinguish one component from another. As used herein, the singular forms “a” and “an” are intended to include the plural forms as well, unless the context clearly indicates otherwise. It will be further understood that the terms “comprises,” “comprising,” “includes,” and/or “including” used herein specify the presence of stated features or components, but do not preclude the presence or addition of one or more other features or components. As used herein, the term “and/or” Includes any and all combinations of one or more of the associated listed items.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

Further, the use of “may” when describing embodiments of the inventive concept refers to “one or more embodiments of the inventive concept.” Also, the term “exemplary” is intended to refer to an example or Illustration.

It will be understood that when an element or layer is referred to as being “on,” “connected to,” “coupled to,” “connected with,” “coupled with,” or “adjacent to” another element or layer, it can be directly on, connected to, coupled to, connected with, coupled with, or adjacent to the other element or layer, or one or more intervening elements or layers may be present. In contrast, when an element or layer is referred to as being “directly on,” “directly connected to,” “directly coupled to,” “directly connected with,” “directly coupled with,” or “immediately adjacent to” another element or layer, there are no intervening elements or layers present.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

The organic light-emitting display apparatus and/or any other relevant devices or components according to embodiments of the present invention described herein may be implemented utilizing any suitable hardware, firmware (e.g. an application-specific integrated circuit), software, or a suitable combination of software, firmware, and hardware. For example, the various components of the organic light-emitting display apparatus may be formed on one integrated circuit (IC) chip or on separate IC chips. Further, the various components of the organic light-emitting display apparatus may be implemented on a flexible printed circuit film, a tape carrier package (TCP), a printed circuit board (PCB), or formed on a same substrate as the organic light-emitting display apparatus. Further, the various components of the organic light-emitting display apparatus may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

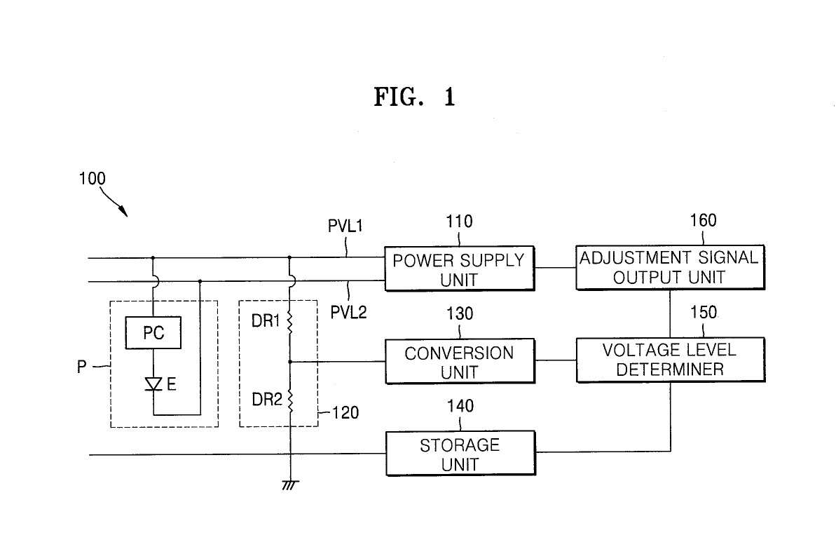

FIG. 1 is a schematic diagram of an organic light-emitting display apparatus 100 according to an embodiment of the present invention.

Referring to FIG. 1, the organic light-emitting display apparatus 100 according to an embodiment of the present invention includes pixels P, a power supply unit (e.g., a power supply) 110, a voltage division unit (e.g., a voltage divider) 120, a conversion unit (e.g., a converter) 130, a storage unit 140, and a voltage level determiner 150. The organic light-emitting display apparatus 100 of the present embodiment may further include an adjustment signal output unit 160. The power supply 110, the voltage divider 120, the converter 130, the storage unit 140, the voltage level determiner 150, and the adjustment signal output unit 160 may be integrated in separate semiconductor chips, or may be integrated as one semiconductor chip.

The organic light-emitting display apparatus 100 may display images through the pixels P. The organic light-emitting display apparatus 100 may be an electronic device itself, for example, a smartphone, a tablet PC, a laptop PC, a monitor, or a TV, or may be a component for image display in the electronic devices.

Each of the pixels P may include a pixel circuit PC receiving a power voltage to control a driving current. The pixel circuit PC may output a voltage supplied to an anode of an organic light-emitting diode (OLED) E based on a first power voltage and a data signal. The pixel P may include the OLED E emitting light with a luminance corresponding to the driving current. The OLED E may emit light corresponding to a difference between a voltage level at the anode of the OLED E and a voltage level at a cathode of the OLED E.

Each of the pixels P may include a plurality of sub-pixels respectively displaying various colors. In the present specification, the pixel P mainly denotes a sub-pixel. However, one or more embodiments of the present invention are not limited thereto, and the pixel P may denote a unit pixel including a plurality of sub-pixels. That is, in the present specification, one pixel P may denote one sub-pixel, or a plurality of sub-pixels together configuring one unit pixel.

The power supply 110 may supply the first power voltage to the pixel circuit PC via a first power line PVL1. The power supply 110 may supply a second power voltage to the cathode of the OLED E via a second power line PVL2. The power supply 110 may receive power from an external power source and/or an internal power source to convert the power into voltages of various levels that are necessary to operate each of the components. The power supply 110 may use a direct current (DC)-DC converter.

In FIG. 1, only one pixel P receiving power from the power supply 110 is shown. However, one or more embodiments of the present invention are not limited thereto, and a plurality of pixels P may receive electric power from the power supply 110.

The voltage divider 120 may receive the first power voltage through the first power line PVL1. The voltage divider 120 divides the first power voltage to generate power division voltages. The voltage divider 120 may include a plurality of division resistors, namely, first and second division resistors DR1 and DR2. For example, the voltage divider 120 may include the first division resistor DR1 and the second division resistor DR2 connected between the first power line PVL1 and the ground in series. The power division voltage that is an output voltage of the voltage divider 120 may be a voltage at a node to which the first division resistor DR1 and the second division resistor DR2 are connected. A level of the power division voltage may be obtained by dividing a level of the first power voltage by a sum of a magnitude of the first division resistor DR1 and a magnitude of the second division resistor DR2, and then, multiplying the division result by the magnitude of the second division resistor DR2, according to Ohm's law.

The magnitude of the first division resistor DR1 and the second division resistor DR2 may be 1 Mohm or greater. In particular, the power supply 110 may supply the first power voltage to various circuits connected to the pixel circuit PC and the first power line PVL1. When the magnitude of first and second division resistors DR1 and DR2 configuring the voltage divider 120 is small, a magnitude of the current flowing to the voltage divider 120 increases according to a current division rule. Then, the magnitude of the current supplied to various circuits connected to the pixel circuit PC and the first power line PVL1 may be reduced, and a degree of reduction in the current may be inverse-proportional to the magnitudes of the first and second division resistors DR1 and DR2 forming the voltage divider 120. Therefore, the first and second division resistors DR1 and DR2 forming the voltage divider 120 may be designed to have high resistance values.

In FIG. 1, the voltage divider 120 includes two resistors, namely, the first and second division resistors DR1 and DR2. However, one or more embodiments of the present invention are not limited thereto, and the voltage divider 120 may be a circuit of various types, which may generate and output an output voltage having a magnitude that is less than that of an input voltage.

The converter 130 may generate a first digital value by performing an analog-to-digital (A/D) conversion of the power division voltage. The converter 130 may be an A/D converter. Operations of the converter 130 will be described later.

The storage unit 140 may store reference digital values. The reference digital values may be generated by performing A/D conversion of reference voltages. The A/D conversion may be performed by the converter 130. The reference voltages may be, for example, a first reference voltage and a second reference voltage. The storage unit 140 may store a first reference digital value generated by the converter 130 to correspond to the first reference voltage. The storage unit 140 may store a second reference digital value generated by the converter 130 to correspond to the second reference voltage. The storage unit 140 may be a storage apparatus such as random access memory (RAM), read only memory (ROM), and/or flash memory.

The first reference voltage may have a level that is the same or substantially the same as the ground level. A conversion table of the converter 130 may be defined so that a digital value generated by performing the A/D conversion of the ground level voltage may be 0. When the level of the input analog voltage of the converter 130 is equal or substantially equal to the ground level, the output digital value may be 0. However, there may be an error during the division of a voltage in the voltage divider 120 or the A/D conversion in the converter 130. Such an error may be caused due to various reasons, for example, an error in the resistance value of the voltage divider 120, resistances of various lines, and Input resistance of the converter 130. Thus, even when the level of the input analog voltage is equal or substantially equal to the ground level, the digital value may not be 0. Therefore, in a case where the level of the first reference voltage is equal or substantially equal to the ground level, the error may be checked by using the first reference digital value. The level of the second reference voltage may be different from that of the first reference voltage.

The voltage level determiner 150 may determine the level of the first power voltage based on the first digital value that is obtained through the A/D conversion of the power division voltage and the reference digital values output from the storage unit 140. For example, the storage unit 140 may store the first reference digital value and the second reference digital value. The voltage level determiner 150 may determine the level of the first power voltage based on the first digital value, the first reference digital value, and the second reference digital value.

The adjustment signal output unit 160 may generate a control signal for adjusting the first power voltage based on the determined level of the first power voltage. The adjustment signal output unit 160 may output the generated control signal to the power supply 110. The adjustment signal output unit 160 may store criteria about the voltage level of the power voltage in a look-up table. The adjustment signal output unit 160 compares the criteria about the level of the power voltage with the level of the first power voltage and generates the control signal according to a difference therebetween. The adjustment signal output unit 160 may perform the comparison between the criteria about the power voltage stored therein with the determined level of the first power voltage with periods (e.g., predetermined periods). The adjustment signal output unit 160 may output the control signal to the power supply 110 at every period (e.g., every predetermined period), or may output the control signal to the power supply 110 only when the difference between the criteria about the power voltage level and the determined level of the first power voltage is equal, substantially equal to, or greater than a degree (e.g., a predetermined degree).

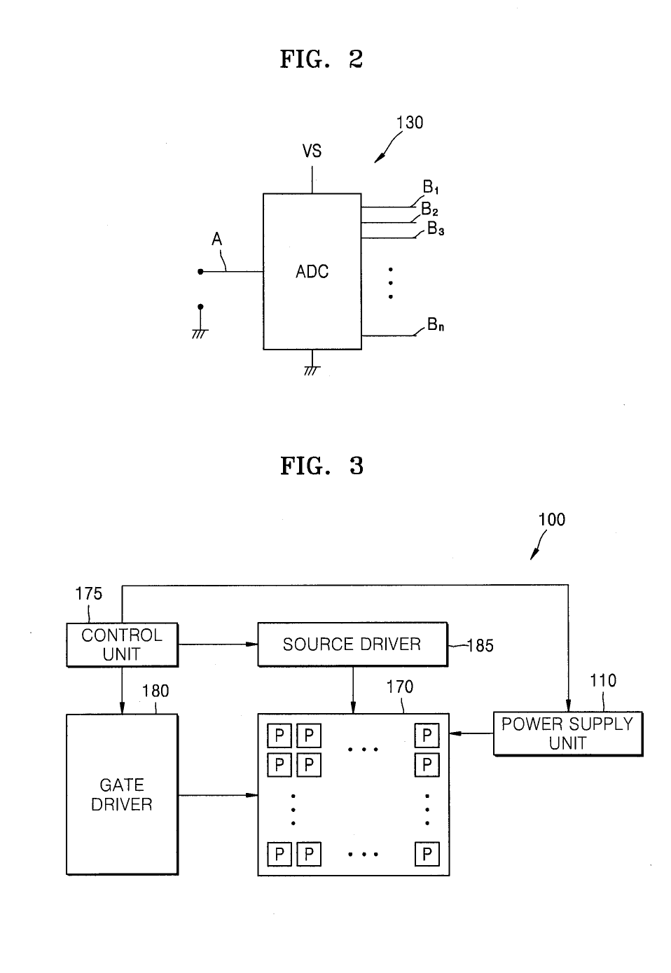

FIG. 2 is a schematic diagram of the converter 130 of FIG. 1.

Referring to FIG. 2, the converter 130 may include an A/D converter ADC. The converter 130 may receive an analog voltage through an analog input line A and may output a digital value.

The converter 130 may compare the input analog voltage with a conversion standard voltage VS via the A/D converter ADC. The A/D converter ADC may convert the analog voltage into a digital value by using the conversion standard voltage VS in various A/D conversion methods. The digital value output from the converter 130 may be represented by a plurality of bits B₁ through Bₙ, the number of which is equal or substantially equal to the number of bits in the output digital value. For example, when the output digital value is a digital value of 10 bits, n may be 10. Thus, the most significant bit of the output digital value may be B₁ and the least significant bit thereof may be B₁₀. The output digital value may be a value, in which B₁ to B₁₀ are sequentially arranged.

The voltage level determiner 150 may determine the digital value corresponding to the input power voltage in consideration of the plurality of reference voltages, the plurality of division resistors, the conversion standard voltage VS of the converter 130, and a function of the number of bits in the output digital value from the converter 130. For example, there may be a case where the reference voltages are the first reference voltage and the second reference voltage, and the division resistors are the first division resistor DR1 and the second division resistor DR2 as shown in FIG. 1. The level of the first reference voltage may be set as C1, the level of the second reference voltage may be set as C2, a value obtained by dividing the magnitude of the first division resistor DR1 by the magnitude of the second division resistor DR2 is C3, the level of the conversion standard voltage VS is C4, the number of bits in the output digital value from the converter 130 is C5, the first reference digital value generated corresponding to the first reference voltage is D1, the second reference digital value generated corresponding to the second reference voltage is D2, and the first digital value generated by the converter 130 to correspond to the power division voltage may be set as DC. A second digital value DM generated by the converter 130 to correspond to the first power voltage may be calculated by using the following Equation 1:

$$DM = ( \frac{C 2 - C 1}{C 3 * C 4} ) * ( {2}^{C 5} ) * ( \frac{DC - D 1}{D 2 - D 1} ) \qquad ( 1 )$$

That is, the first reference digital value D1 generated by the converter 130 to correspond to the first reference voltage is subtracted from the digital value DC generated by the converter 130 to correspond to the power division voltage, and then, the subtraction result value is divided by a value obtained by subtracting the first reference digital value D1 from the second reference digital value D2 generated by the converter 130 to correspond to the second reference voltage, so as to correct the error. The calculated value is scaled using the values C1 to C5 to obtain a result corresponding to the number of bits in the output digital value from the converter 130. The voltage level determiner 150 may generate the second digital value using various suitable methods, in addition to the calculating method using Equation 1.

The voltage level determiner 150 may determine the level of the first power voltage using the second digital value in various suitable ways. For example, the voltage level determiner 150 may perform a digital to analog conversion of the second digital value to determine the level of the first power voltage, or the voltage level determiner 150 may determine the level of the first power voltage using the look-up table storing levels of the voltages corresponding to various digital values. When the second digital value is calculated using a function of Equation 1 and the level of the first power voltage is determined from the second digital value, an error that may occur when the division resistors included in the voltage divider 120 have large magnitudes, that is, 1 Mohm or greater, may be reduced effectively. Thus, the level of the first power voltage may be determined with high accuracy.

FIG. 3 is a schematic diagram of an organic light-emitting display apparatus 100 according to another embodiment of the present invention.

Referring to FIG. 3, the organic light-emitting display apparatus 100 of the present embodiment may include the power supply unit (e.g., a power supply) 110, a display unit (e.g., display 170), a control unit (e.g., a controller) 175, a gate driver 180, and a source driver 185. The organic light-emitting display apparatus 100 according to the embodiment of FIG. 3 is different from that of FIG. 1 in view of further including some components, and the difference from FIG. 1 will be described below.

A plurality of pixels P may be disposed on the display 170. The display 170 may be various suitable kinds of flat display panels. A plurality of scan lines and a plurality of data lines may be arranged on the display 170. The plurality of pixels P may be disposed where the plurality of scan lines and the plurality of data lines cross each other on the display 170.

The controller 175 may output signals that are necessary for displaying images. The controller 175 may output control signals for controlling the power supply 110, the display 170, the gate driver 180, and the source driver 185. The controller 175 may control the power supply 110 to supply a voltage to the display 170. The controller 175 may control the gate driver 180 to generate scan signals. The controller 175 may output image data to the source driver 185 and may control the source driver 185 to output data signals to the display 170 in synchronization with the scan signals.

The gate driver 180 may output the scan signals to the pixels P of the display 170 via the plurality of scan lines.

The source driver 185 may output the data signals to the pixels P of the display 170 via the plurality of data lines. The source driver 185 may output the data signals in synchronization with the scan signals.

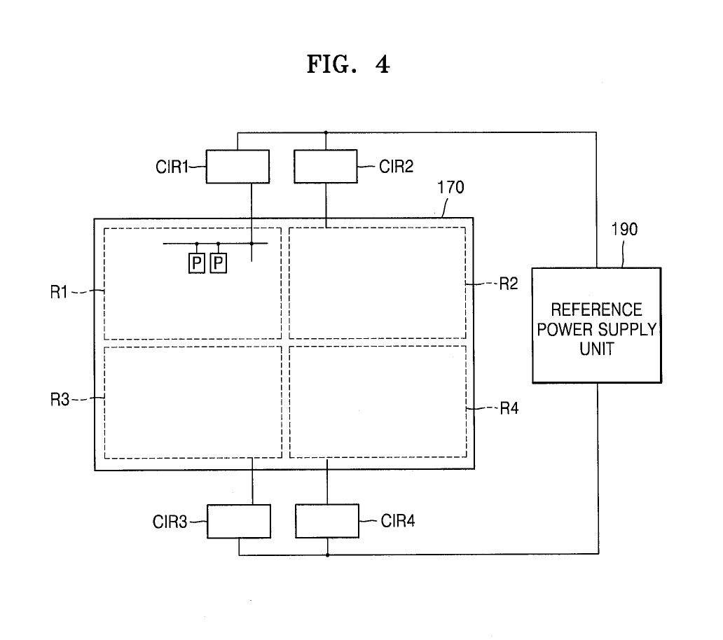

FIG. 4 is a schematic diagram of an organic light-emitting display apparatus 100 according to another embodiment of the present invention.

Referring to FIG. 4, the organic light-emitting display apparatus 100 according to the present embodiment of the present invention may include the display unit (e.g., display) 170, a plurality of circuits CIR1 through CIR4, and a reference power supply unit (e.g., power supply) 190. The organic light-emitting display apparatus 100 according to the embodiment of FIG. 4 is different from those of FIG. 1 and FIG. 3 in the embodiment of FIG. 4 which includes additional elements (or components), and the difference will be described below.

A plurality of regions R1 through R4 may be defined on the display 170, and a plurality of pixels P may be disposed in each of the plurality of regions R1 through R4. In FIG. 4, four regions R1 through R4 are defined. However, one or more embodiments of the present invention are not limited thereto, and two or more regions may be defined on the display 170.

The plurality of circuit units (e.g., circuits) CIR1 through CIR4 may supply power voltages to the plurality of pixels P in the plurality of regions R1 through R4, respectively. Each of the plurality of circuits CIR1 through CIR4 may include the power supply 110, the voltage divider 120, the converter 130, the storage unit 140, the voltage level determiner 150, and the adjustment signal output unit 160 (see FIG. 1) shown in FIG. 1.

The voltage level determiner 150 included in each of the plurality of circuits CIR1 through CIR4 may share the determined level of the power voltage with the others. The determined level of the power voltages may be shared through lines connected between the voltage level determiners 150 included in the plurality of circuits CIR1 through CIR4, or the adjustment signal output units 160 included in the plurality of circuits CIR1 through CIR4 may share the levels of the power voltages, which are input thereto. The adjustment signal output units 160 included in the plurality of circuits CIR1 through CIR4 may output the adjustment signals based on difference between the shared levels of the power voltages. The adjustment signal output unit 160 included in each of the circuits CIR1 through CIR4 may output the adjustment signal in consideration of the IR drop. For example, the IR drop in the first region R1 may be greater than that of the second region R2. Even when the same image is displayed on the first region R1 and the second region R2, the level of the power voltage supplied to the first region R1 may be greater than that of the power voltage supplied to the second region R2.

FIG. 4 shows four circuits CIR1 through CIR4. However, one or more embodiments are not limited thereto, and the organic light-emitting display apparatus 100 according to the present embodiment of the present invention may include a plurality of circuits corresponding to the number of plurality of regions defined on the display 170.

The reference power supply 190 may supply a plurality of reference voltages to the plurality of circuits CIR1 through CIR4. The plurality of reference voltages may be voltages for generating a plurality of reference digital values. The plurality of reference voltages may include a first reference voltage and a second reference voltage. The storage units 140 included in the plurality of circuits CIR1 through CIR4 may store the reference digital values generated using the reference voltages supplied from the reference power supply 190.

In FIG. 4, the reference power supply 190 supplies the reference voltages to all of the plurality of circuits CIR1 through CIR4. However, one or more embodiments of the present invention are not limited thereto, and a plurality of reference power supplies 190 may supply the reference voltages respectively to the plurality of circuits CIR1 through CIR4, or each of the plurality of circuits CIR1 through CIR4 may include the reference power supply 190. However, a light emission intensity of the OLED in the organic light-emitting display apparatus 100 may be changed sensitively according to the amount of current flowing in the OLED. Since the amount of current is determined by the power voltage, the level of the power voltage has to be determined with high accuracy. Therefore, in a case where one reference power supply 190 supplies the reference voltages to the plurality of circuits CIR1 through CIR4, an error between the reference voltages of the plurality of circuits CIR1 through CIR4 may be a very small value.

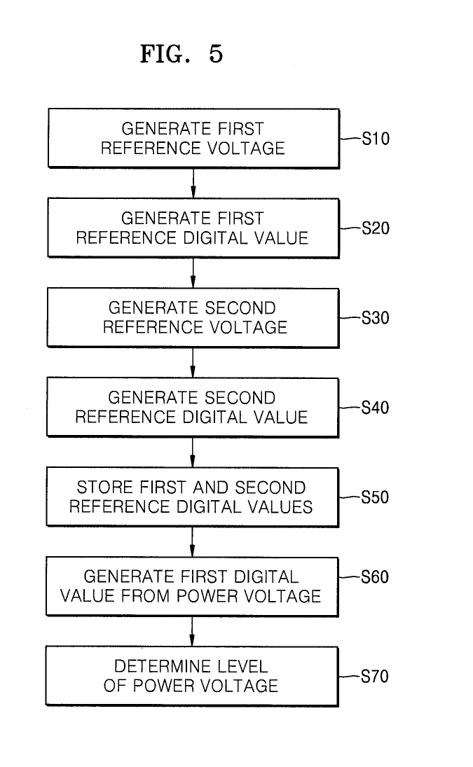

FIG. 5 is a flowchart illustrating a method of driving an organic light-emitting display apparatus, according to an embodiment of the present invention.

Referring to FIG. 5, the method of driving the organic light-emitting display apparatus, according to the present embodiment of the present invention, may include generating the first reference voltage (S10), generating the first reference digital value (S20), generating the second reference voltage (S30), generating the second reference digital value (S40), storing the first reference digital value and the second reference digital value (S50), generating the first digital value based on the power voltage (S60), and determining the level of the power voltage (S70).

In operation S10, the first reference voltage may be generated. The first reference voltage may be generated by the power supply included in the organic light-emitting display apparatus. A level of the first reference voltage may be equal or substantially equal to a ground level. A level of the power voltage before applying power or right after applying the power to the organic light-emitting display apparatus may be equal or substantially equal to the ground level. Therefore, when the level of the first reference voltage is equal or substantially equal to the ground level, the power supply may not generate the first reference voltage, but may determine the voltage of a power line before generating electric power from the power supply as the first reference voltage.

In operation S20, the first reference voltage is A/D-converted to generate the first reference digital value. The first reference digital value may be generated by the converter included in the organic light-emitting display apparatus.

In operation S30, the second reference voltage that is different from the first reference voltage may be generated. The second reference voltage may be generated by the power supply included in the organic light-emitting display apparatus.

In operation S40, the second reference voltage is A/D-converted to generate the second reference digital value. The second reference digital value may be generated by the converter included in the organic light-emitting display apparatus.

In operation S50, the first reference digital value and the second reference digital value may be stored. The first and second reference digital values may be stored in various storage devices such as RAM, ROM, and/or flash memory.

In operation S60, the first digital value may be generated based on the power voltage output from the power supply. In operation S60, the power voltage may be divided to generate the power division voltages, and the power division voltage may be A/D-converted to generate the first digital value.

In operation S70, the level of the power voltage may be determined based on the first reference digital value, the second reference digital value, and the first digital value. In operation S70, the second digital value corresponding to the level of the power voltage may be determined based on the first reference digital value, the second reference digital value, and the first digital value. Then, the level of the power voltage may be determined based on the second digital value.

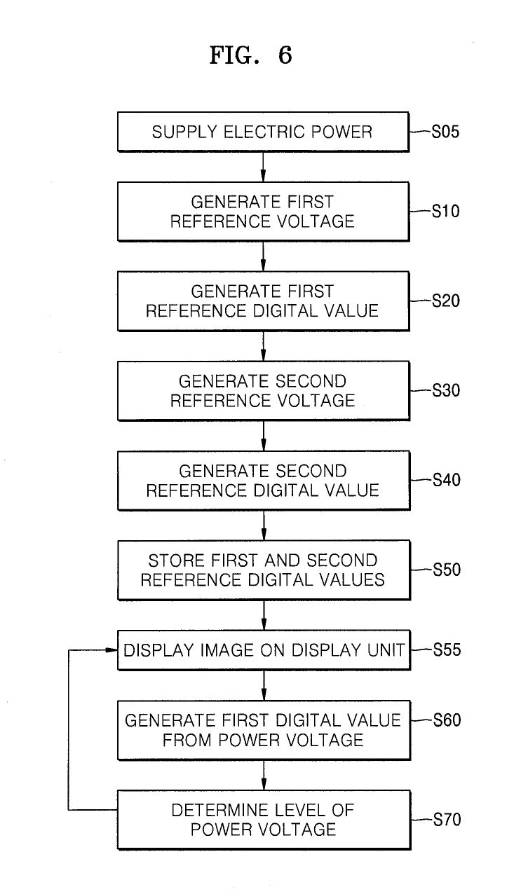

FIG. 6 is a flowchart illustrating a method of driving an organic light-emitting display apparatus, according to another embodiment of the present invention.

Referring to FIG. 6, the method of driving the organic light-emitting display apparatus, according to the present embodiment of the present invention, includes supplying electric power to the organic light-emitting display apparatus (S05), generating the first reference voltage (S10), generating the first reference digital value (S20), generating the second reference voltage (S30), generating the second reference digital value (S40), storing the first digital value and the second digital value (S50), displaying an image on the display of the organic light-emitting display apparatus (S55), generating the first digital value based on the power voltage (S60), and determining the level of the power voltage (S70). The method according to the embodiment of FIG. 6 further includes some operations in addition to the ones of the method according to the embodiment of FIG. 5, and differences of the present embodiment of the present invention from the previous embodiment of FIG. 5 will be described below.

In operation S05, electric power may be supplied to the organic light-emitting display apparatus. Operation S05 may be a process of supplying electric power to the controller that controls the display, the gate driver, the source driver, and the power supply.

In operation S55, the Image may be displayed by the pixels on the display.

From a time point when (or at which) electric power is supplied to the organic light-emitting display apparatus to a time point when an Image is displayed on the display of the organic light-emitting display apparatus, operations S10 to S50 may be performed. That is, processes of generating and storing the reference digital values that are necessary for determining the power voltage may be performed between the time point when electric power is supplied to the organic light-emitting display apparatus and the time point when the image is displayed on the display of the organic light-emitting display apparatus. Thus, the method of driving the organic light-emitting display apparatus, according to the present embodiment, may be performed. Also, the stored first digital value and the second digital value may be used without being changed during the operation of the organic light-emitting display apparatus. Therefore, after performing operation S70, operations S55 to S70 may be repeatedly performed but not operations S10 to S50.

As described above, according to the one or more of the above exemplary embodiments of the present invention, a level of the power voltage in the organic light-emitting display apparatus may be measured.

Unless otherwise defined, the ranges defined herein are intended to include any invention to which values within the range are individually applied and may be considered to be the same as individual values constituting the range in the detailed description of the present invention.

Operations constituting the method of embodiments of the present invention may be performed in appropriate order unless explicitly described in terms of order or described to the contrary. The present invention is not necessarily limited to the order of operations given in the description. The examples or exemplary terms used herein are to merely describe the present invention in detail and not intended to limit the present invention unless defined by the following claims. Also, those of ordinary skill in the art will readily appreciate that many alternation, combination and modifications, may be made according to design conditions and factors within the scope of the appended claims and their equivalents.

It should be understood that the exemplary embodiments of the present invention described therein should be considered in a descriptive sense only and not for purposes of limitation. Descriptions of features or aspects within each exemplary embodiment of the present invention should typically be considered as available for other similar features or aspects in other exemplary embodiments of the present invention.

While one or more exemplary embodiments have been described with reference to the figures, it will be understood by those of ordinary skill in the art that various changes in form and details may be made therein without departing from the spirit and scope as defined by the following claims and their equivalents.

What is claimed is:

1. An organic light-emitting display apparatus comprising:
a pixel comprising:
a pixel circuit;
a power supply configured to supply a first power voltage to the pixel circuit;
a voltage divider configured to generate a power division voltage by dividing the first power voltage;
a converter configured to generate a first digital value by performing an analog to digital (A/D) conversion of the power division voltage;
a storage unit configured to store a first reference digital value generated by the converter, the first reference digital value corresponding to a first reference voltage and a second reference digital value generated by the converter, the second reference digital value corresponding to a second reference voltage that is different from the first reference voltage; and
a voltage level determiner configured to determine a level of the first power voltage based on the first digital value, the first reference digital value, and the second reference digital value.

2. The organic light-emitting display apparatus of claim 1, wherein the voltage divider comprises:
a first division resistor; and
a second division resistor,
wherein the first division resistor and the second division resistor are connected between an output terminal of the power supply and a ground in series.

3. The organic light-emitting display apparatus of claim 2,
wherein when it is assumed that:
a level of the first reference voltage is C1;
a level of the second reference voltage is C2;
a value obtained by dividing a magnitude of the first division resistor by a magnitude of the second division resistor is C3;
a level of a reference voltage for the A/D conversion is C4;
a number of bits in the first digital value is C5;
the first reference digital value is D1;
the second reference digital value is D2; and
the first digital value obtained by converting an output voltage of the voltage divider by the converter is DC,
the voltage level determiner is configured to calculate a second digital value DM generated by the converter, the second digital value DM corresponding to the first power voltage by using the following equation:
$$DM = ( \frac{C 2 - C 1}{C 3 * C 4} ) * ( {2}^{C 5} ) * ( \frac{DC - D 1}{D 2 - D 1} ) ,$$
and the voltage level determiner is configured to determine the level of the first power voltage using the second digital value.

4. The organic light-emitting display apparatus of claim 2,
wherein a magnitude of the first division resistor and a magnitude of the second division resistor are 1 Mohm or greater, respectively.

5. The organic light-emitting display apparatus of claim 1, further comprising:
an adjustment signal output unit configured to generate a control signal for adjusting the first power voltage based on the determined level of the first power voltage and to output the control signal to the power supply.

6. The organic light-emitting display apparatus of claim 1,
wherein the pixel comprises an organic light-emitting diode (OLED) configured to receive a driving current from the pixel circuit, and
wherein the power supply is configured to supply a second power voltage to a cathode of the OLED.

7. The organic light-emitting display apparatus of claim 1,
wherein the level of the first reference voltage is substantially equal to a ground level.

8. The organic light-emitting display apparatus of claim 1, further comprising:
a display on which the pixel is disposed;
a gate driver configured to output a scan signal;
a source driver configured to output a data signal to the pixel in synchronization with the scan signal; and
a controller configured to control the gate driver and the source driver.

9. An organic light-emitting display apparatus comprising:
a display on which a plurality of regions are defined and comprising a plurality of pixels; and
a plurality of circuits configured to:
supply a power voltage to pixels on regions corresponding to the plurality of circuits among the plurality of regions;
generate a power division voltage by dividing the power voltage;
generate a first digital value by performing an analog to digital (A/D) conversion of the power division voltage; and
determine a level of the power voltage based on a first reference digital value corresponding to a first reference voltage, a second reference digital value corresponding to a second reference voltage, and the first digital value,
wherein the second reference voltage is different from the first reference voltage.

10. The organic light-emitting display apparatus of claim 9, further comprising:
a reference power supply configured to supply the first reference voltage and the second reference voltage to the plurality of circuits.

11. The organic light-emitting display apparatus of claim 9, wherein each of the plurality of circuits comprises:
a power supply configured to supply the power voltage to the pixels on the region corresponding to the circuit among the plurality of regions;
a voltage divider configured to generate the power division voltage by dividing the power voltage;
a converter configured to generate the first digital value by performing the A/D conversion of the power division voltage;
a storage unit configured to store:
the first reference digital value generated by the converter, the first reference digital value corresponding to the first reference voltage; and
the second reference digital value generated by the converter, the second reference digital value corresponding to the second reference voltage; and
a voltage level determiner configured to determine a level of a first power voltage based on the first digital value, the first reference digital value, and the second reference digital value.

12. The organic light-emitting display apparatus of claim 11,
wherein the voltage divider in each of the plurality of circuits comprises a first division resistor and a second division resistor that are connected between an output terminal of the power supply and a ground in series.

13. The organic light-emitting display apparatus of claim 11, wherein each of the plurality of circuits comprises:
an adjustment signal output unit configured to:
generate a control signal for adjusting the first power voltage based on the determined level of the first power voltage, and
output the control signal to the power supply.

14. The organic light-emitting display apparatus of claim 9, further comprising:
a gate driver configured to output a scan signal;
a source driver configured to output a data signal to the plurality of pixels in synchronization with the scan signal; and
a controller configured to control the gate driver and the source driver.

15. A method of driving an organic light-emitting display apparatus, the method comprising:
generating a first reference voltage;
generating a first reference digital value through an analog to digital (A/D) conversion of the first reference voltage;
generating a second reference voltage that is different from the first reference voltage;
generating a second reference digital value through an A/D conversion of the second reference voltage;
storing the first reference digital value and the second reference digital value;
generating a first digital value based on a power voltage supplied to a display; and
determining a level of the power voltage based on the first reference digital value, the second reference digital value, and the first digital value.

16. The method of claim 15, wherein the generating of the first reference voltage, the generating of the first reference digital value, the generating the second reference voltage, the generating of the second reference digital value, and the storing of the first reference digital value, and the second reference digital value are performed between a time point at which electric power is supplied to the organic light-emitting display apparatus and a time point at which an image is displayed on the display.
